(19) United States
(12) Patent Application Publication
(10) Pub. No.: US 2024/0317280 A1
(43) Pub. Date: Sep. 26, 2024

(54) SWEPT PATTERN PROBABILITY CALCULATION FOR SPEED AND DEFECT IDENTIFICATION

(71) Applicant: Aktiebolaget SKF, Göteborg (SE)

(72) Inventor: Allan Thomson, Lanark (GB)

(21) Appl. No.: 18/679,865

(22) Filed: May 31, 2024

Related U.S. Application Data
(63) Continuation-in-part of application No. 16/995,986, filed on Aug. 18, 2020.

(51) Int. Cl. B61L 15/00; G01M 13/045

(52) U.S. Cl. CPC B61L 15/0081; G01M 13/045

(57) ABSTRACT

A method and system is provided for performing speed and defect identification of a component such as, for example, a bearing. The method can be implemented by a computer, such that the computer receives from one or more sensors condition monitoring data. The computer sweeps patterns along a speed range against the condition monitoring data and multiplies each pattern component of the patterns by a matching environmental spectral component. The computer, then, adds the pattern components together to produce one or more results.

### CROSS REFERENCE TO RELATED APPLICATIONS

The present application is a continuation-in part of and claims priority to and benefit of U.S. patent application Ser. No. 16/995,986, which was filed on Aug. 18, 2020, which is hereby incorporated by reference in its entirety as if fully set forth herein.

### BACKGROUND

A train can have many rail cars, each of which can have multiple axles and corresponding axle boxes. Each axle box can have installed therein bearings, whether from the same or different manufacturers. Overtime, bearings develop defects due to numerous causes (e.g., contamination, surface imperfections, lubrication issues, etc.), which can be detected within vibration harmonics of the bearings. The field of collecting and monitoring these vibration harmonics, along with addressing defects detected in these vibration harmonics, is referred to as condition monitoring.

Further, whether the conventional condition monitoring applications are on-line and off-line, installing, utilizing, and maintaining a shaft speed sensor in support of collecting and monitoring bearing vibration harmonics can be problematic and/or expensive. For example, conventional condition monitoring applications require knowledge of a shaft speed to within a few % of tolerance to identify vibration spectrum frequency components/symptoms associated with bearing defects within the bearing vibration harmonics. Even with knowledge of the approximate shaft speed, conventional condition monitoring applications are redundant or unreliable, and the bearing defect goes undetected by these applications.

In conventional condition monitoring applications, managing parameters which can affect shaft speed calculations such as wheel diameters for each axle-box, for example, and updating a database in a timely fashion is costly with respect to man-hours, while also being prone to errors.

### SUMMARY

According to one or more embodiments, a method is provided herein. The method can be implemented by a computer, such that the computer receives from one or more sensors condition monitoring data. The computer sweeps patterns along a speed range against the condition monitoring data and multiplies each pattern component of the patterns by a matching direct or interpolated environmental spectral component. The interpolated environmental spectral component can be determined by performing a linear or polynomial analysis that matches a pattern component to a corresponding environmental spectral component. The computer, then, adds the pattern components together by one or more methods to produce one or more results.

According to one or more embodiments, a method is provided herein. The method of monitoring a bearing on a machine without having to know the speed of operation of the bearing, preferably includes: providing a shaft disposed on the machine, the shaft having a first axial end; providing a first bearing disposed on the first axial end of the shaft; providing a first sensor, located on the first bearing and configured to provide first bearing condition monitoring data which comprises vibration data; providing a computer in communication with the first sensor; automatically receiving, by the computer, of the first bearing condition monitoring data and processing the vibration data into frequency domain to generate a spectral array of amplitudes and frequencies; providing a plurality of patterns each representing a particular defect symptom and each comprising an array of relative frequencies and being weighted such that their root-sum-squared is a maximum of 1 regardless of the size of the array of relative frequencies so that a maximum match between the first bearing condition monitoring data and the one of the plurality of patterns which corresponds to the defect yields a pattern correlation value of greatest magnitude; and wherein the computer, upon receiving the first bearing condition data from the first bearing, compares a first pattern thereto to determine a pattern correlation value for the first pattern.

According to one or more embodiments, a method is provided herein. The method of monitoring a bearing on a machine without having to know the speed of operation of the bearing, preferably includes the steps of: providing a shaft disposed on the machine, the shaft having a first axial end; providing a first bearing disposed on the first axial end of the shaft; providing a first sensor, located on the first bearing and configured to provide first bearing condition monitoring data which comprises vibration data; providing a computer in communication with the first sensor; automatically receiving, by the computer, of the first bearing condition monitoring data and processing the vibration data into frequency domain to generate a spectral array of amplitudes and frequencies; providing a plurality of patterns each representing a particular defect symptom and each comprising of arrays of relative frequencies, relative to the fundamental frequency thereof, and corresponding weighting values such that their root-sum-squared is a maximum of 1, regardless of the number of frequency components therein, so that a maximum match between the first bearing condition monitoring data and the one of the plurality of patterns which corresponds to the defect yields a highest value; and wherein the computer, upon receiving the first bearing condition data from the first bearing, compares a first pattern thereto to determine a pattern correlation value for the first pattern.

According to one or more embodiments, a method is provided herein. The method of monitoring a bearing on a machine without having to know the speed of operation of the bearing, preferably including the steps of: providing a shaft disposed on the machine, the shaft having a first axial end; providing a first bearing disposed on the first axial end of the shaft; providing a first sensor, located on the first bearing and configured to provide first bearing condition monitoring data which comprises vibration data; providing a computer in communication with the first sensor; automatically receiving, by the computer, of the first bearing condition monitoring data and processing the vibration data into frequency domain to generate a spectral array of amplitudes and frequencies; providing a plurality of patterns each representing a particular defect symptom and each comprising of arrays of relative frequencies, determining a maximum match between the first bearing condition monitoring data and the one of the plurality of patterns which corresponds to the defect which is most probable in view of the first bearing condition monitoring data; and wherein the computer, upon receiving the first bearing condition data from the first bearing, automatically determines a pattern correlation value for the first pattern.

According to one or more embodiments, the above method can be implemented as a system, apparatus, and/or a computer program product.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The foregoing summary, as well as the following detailed description of the preferred embodiments of the present invention will be better understood when read in conjunction with the appended drawings. For the purpose of illustrating the invention, there are shown in the drawings embodiments which are presently preferred. At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. It is understood, however, that the invention is not limited to the precise arrangements and instrumentalities shown. In the drawings:

FIG. 1 depicts a system in accordance with one or more embodiments;

FIG. 2 depicts a process flow in accordance with one or more embodiments;

FIG. 3 depicts a graph in accordance with one or more embodiments;

FIG. 4 depicts an example algorithm in accordance with one or more embodiments;

FIG. 5 depicts the frequency spectrum illustrating the fundamental frequency of a BPFO defect. There is a lack of a relatively few side bands with near shaft speed delta frequencies around each harmonic of the defect fundamental frequency.

FIG. 6 depicts the frequency spectrum illustrating the fundamental frequency of a BPFI defect. There are significant amount of side bands with side bands near shaft speed delta frequencies around each harmonic of the defect fundamental frequency.

FIG. 7 illustrates a pattern of a TBU BPFO pattern without weighting or normalization.

FIG. 8 illustrates a pattern of a TBU BPFI pattern without weighting or normalization.

FIG. 9 is a table illustrating a weighting calculation method from orders and sideband weighting coefficients.

FIG. 10 illustrates the weighted pattern of a TBU BPFI pattern after weighting, but without normalization.

FIG. 11 illustrates the normalized weighted pattern of a TBU BPFI pattern after weighting and normalization.

FIG. 12 illustrates the normalized weighted pattern of a TBU BPFO pattern after weighting and normalization.

FIG. 13 illustrates the sweep pattern of the fundamental frequency range of the fundamental and its harmonics. Only the pattern is shown and not the frequency.

FIG. 14 illustrates how for each weep step of the fundamental frequency a sideband sweep can be performed around the fundamental frequency and its harmonics.

FIG. 15 illustrates a vertical axis that corresponds to correlation values and a diagonal axis that corresponds to sideband frequency steps.

FIG. 16 illustrates a condition where due to BPFO “maxima correlation value” being higher than the BPFI the defect is classified as BPFO.

FIG. 17 illustrates a condition where due to BPFI “maxima correlation value” being higher than the BPFO the defect is classified as BPFI.

FIG. 18 illustrates the acquired spectrum with the x-axis showing frequency in Hertz.

FIG. 19 illustrates the condition where the approximate shaft speed is known or calculated with the x-axis showing orders of running speed.

FIG. 20 illustrates a condition when a noise filter is applied to the spectrum which converts all spectral components with values below +10 db above the local carpet level to identify the peaks of interest to be included in the peak arrays which are far fewer in number than the peaks and spectral bins in the raw spectra.

FIG. 21 illustrates when the raw spectrum and applying of the quadratic peak interpolation in the noise filtered spectrum, to extract the exact frequency and amplitude of each peak thus creating a peak array list represented by the dots.

FIG. 22 illustrates the quadratic peak interpolation method being used to calculate the peaks center frequency and true amplitude using the three highest values adjacent to the spectral peak maxima point.

FIG. 23 illustrates the operation of the “reverse sweep” method of identifying possible harmonic (orders of) fundamental frequencies for each component in the “peak array” list with clustering into groups or outliers. This can be used to identify running speed and harmonics within its range and remove them from the “peak array” list prior to searching by the same method the bearing defect ranges.

FIG. 24 illustrates a condition when running speed harmonics are removed with the “peak arrays” shown as dots.

FIG. 25 illustrates the results of performing the sideband reverse sweep with clustering in the bearing BPFI sideband defect range and sideband group filtering to identify feasible sidebands relating to the BPFI defect. The previously designed patterns are applied to these results when BPFO and BPFI ranges overlap to improve classification of the defect type by their “correlation values.”

FIG. 26 illustrates the reverse sweep method of identifying possible sidebands of each harmonic (orders of) fundamental frequencies identified as being related to a clustering into sideband group or outliers.

FIG. 27 illustrates exemplary results of a sideband reverse sweep with clustering in the bearing BPFI sideband defect range and sideband group filtering to identify feasible sidebands relating to the BPFI defect. The previously designed patterns are applied to these results when BPFO and BPFI ranges overlap to improve classification of the defect type by their “correlation values”.

FIG. 28 is a chart of experimental results from field trials of one embodiment of the present invention.

### DETAILED DESCRIPTION

Certain terminology is used in the following description for convenience only and is not limiting. The words “right,” “left,” “up,” and “down” designate the directions as they would be understood by a person facing in the viewing direction unless specified otherwise. At least one of the embodiments of the present invention is accurately represented by this application's drawings which are relied on to illustrate such embodiment(s) to scale and the drawings are relied on to illustrate the relative size, proportions, and positioning of the individual components of the present invention accurately relative to each other and relative to the overall embodiment(s). Those of ordinary skill in the art will appreciate from this disclosure that the present invention is not limited to the scaled drawings and that the illustrated proportions, scale, and relative positioning can be varied without departing from the scope of the present invention as set forth in the broadest descriptions set forth in any portion of the originally filed specification and/or drawings. The words “outer” and “inner” refer to directions away from and toward, respectively, the geometric center of the specified element, or, if no part is specified, the geometric center of the invention. The terms “downward” and “upward refers to directions above and below the referenced component, respectively, unless specified otherwise. Those of ordinary skill in the art will appreciate from this disclosure that when a range is provided such as (for example) an angle/distance/number/weight/volume/spacing being between one (1 of the appropriate unit) and ten (10 of the appropriate units) that specific support is provided by the specification to identify any number within the range as being disclosed for use with a preferred embodiment. For example, the recitation of a percentage of copper between one percent (1%) and twenty percent (20%) provides specific support for a preferred embodiment having two point three percent (2.3%) copper even if not separately listed herein and thus provides support for claiming a preferred embodiment having two point three percent (2.3%) copper. By way of an additional example, a recitation in the claims and/or in portions of an element moving along an arcuate path by at least twenty (20°) degrees, provides specific literal support for any angle greater than twenty (20°) degrees, such as twenty-three (23°) degrees, thirty (30°) degrees, thirty-three-point five (33.5°) degrees, forty-five (45°) degrees, fifty-two (52°) degrees, or the like and thus provides support for claiming a preferred embodiment with the element moving along the arcuate path thirty-three-point five (33.5°) degrees. The language “at least one of ‘A’, ‘B’, and ‘C’,” as used in the claims and in corresponding portions of the specification, means “any group having at least one ‘A’; or any group having at least one ‘B’; or any group having at least one ‘C’; —and does require that a group have at least one of each of ‘A’, ‘B’, and ‘C’.” More specifically, the language ‘at least two/three of the following list’ (the list itemizing items ‘1’, ‘2’, ‘3’, ‘4’, etc.), as used in the claims, means at least two/three total items selected from the list and does not mean two/three of each item in the list. The term “interior”, as used in the claims and corresponding portions of the specification means the area proximate to the center of the invention. The term “exterior” similarly defines the area not in proximity to the center of the invention. Additionally, the words “a” and “one” are defined as including one or more of the referenced items unless specifically stated otherwise. The terminology includes the words specifically mentioned above, derivatives thereof, and words of similar import.

Embodiments herein relate to a swept pattern probability calculation (SPPC) for speed and defect identification within bearings. In accordance with one or more embodiments, an SPPC auto-detection algorithm can be implemented by one or more devices to auto-detect bearing defects on bearings and associated machinery without the need to know an exact shaft speed. The bearing defects on the bearings and the associated machinery can include, but are not limited to, when spalls or flakes of the bearing break off (e.g., by spalling and spallation) of a bearing raceway (inner or outer) and/or roller and/or a cage thereof, as a result of brinelling, false brinelling, corrosion, contamination, lack of lubrication, or excessive rolling pressure.

For example, because bearings of railway axle-boxes and the associated machinery can provide a vibration spectrum (e.g., bearing vibration harmonics) during use, defect components/symptoms can become present in the vibration spectrum as the bearing defects develop. The SPPC auto-detection algorithm utilizes inner and outer raceways, roller and/or cage defect specific patterns to identify the most probable defect components/symptoms present in railway axle-box bearings and the associated machinery, and identify the exact shaft speed. The exact shaft speed can be utilized to perform further diagnostic operations and/or degradation analysis. While embodiments herein are described with respect to railway axle-boxes, the embodiments herein are not limited thereto. That is, although embodiments herein relate to deal with rail condition monitoring errors such as wheel diameter management errors required to convert global position system (GPS) linear speed to shaft rotational speed, embodiments herein are suited to many condition monitoring applications across many industries where a tachometer or speed input is not fitted or available.

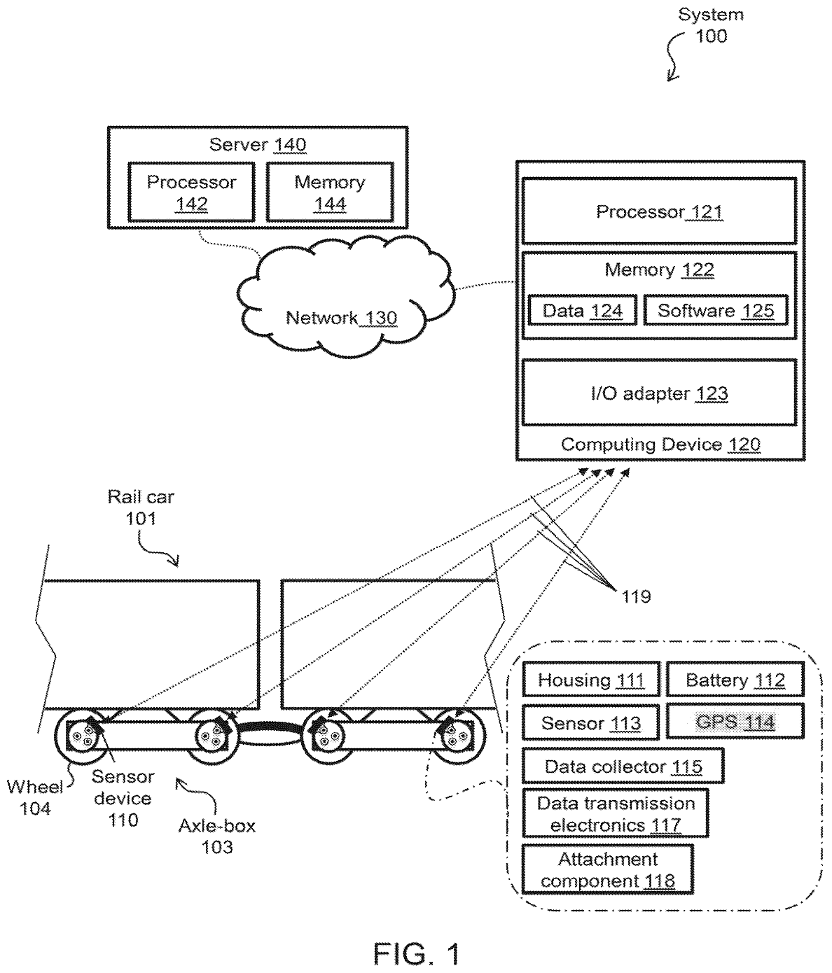

FIG. 1 depicts a system 100 in accordance with one or more embodiments. The system 100 includes at least one railcar 101 including at least one axle-box 103. The axle-box 103 includes one or more wheels 104 (e.g., a rail bogie wheel) attached thereto by fastening elements. Note that, while only a single axle-box is show, most railcars have two bogies hence two axles with eight wheels and eight axle-boxes attached thereto (for example, by a rail bogie wheel axle-box bearing). In general, a bearing housing of the axle-box 103 includes a rail bogie wheel axle-box bearing (e.g., the bearing(s)) that supports a corresponding wheel 104 and a bolt configuration that attaches the bearing housing to the axle-box 103. For example, trains typically include two to an excess of seventy rail cars 101, which means thousands of bearings can be present within a system 100 including a fleet of trains.

Further, a system 100 is generally shown in accordance with one or more embodiments. The system 100 can include an electronic, computer framework comprising and/or employing any number and combination of computing device and networks utilizing various communication technologies, as described herein. The system 100 can be easily scalable, extensible, and modular, with the ability to change to different services or reconfigure some features independently of others.

The system 100 includes at least one sensor device 110 of a plurality of condition monitoring sensor devices. Each sensor device 110 is an electronic device that can include a housing 111, a battery 112, at least one sensor 113 (e.g., transducers for vibration, temperature, etc.), a data collector 115 (e.g., a processor and a memory as described herein), a GPS 114, data transmission electronics 117 (e.g., a wireless modem and/or a near field communication (NFC) transponders), and an attachment component 118 that affixes the sensor device 110 to the wheel 104 (e.g., one of the plurality of securing bolts thereof). The attachment component 118 can be any bracket, flange, or the like that attaches the sensor device 110 to a mechanical system to be monitored.

For example, each sensor device 110 can be a compact, battery-operated device (e.g., using the battery 112) that measures static and dynamic data of the bearing of the wheel 104 (e.g., condition monitoring data) to which it is attached (e.g., specifically, being attached to least one of the fastening elements of that wheel 104). Via the data transmission electronics 117, each sensor device 110 can wirelessly transmit (as represented by double arrows 119) the condition monitoring data to devices, servers, and systems, such as a computing device 120.

In accordance with one or more embodiments, the memory of the data collector 115 and/or the data transmission electronics 117 of each sensor device 110 can store the condition monitoring and/or be associated with a unique sensor identifier. For instance, an NFC transponder can be pre-programmed with a unique sensor identifier associated with a wireless modem internal to a sensor device 110 and/or can be pre-programmed with details relating to that specific sensor and mounting location (e.g., whether it is mounted on or near a rail bogie wheel axle-box bearing). Further, at various pre-defined intervals and with speed gating (e.g., such as while the railcar 101 is moving and not parked parking in a rail yard, the sensor device 110 records the condition monitoring data.

The computing device 120 includes one or more central processing units (CPU(s)) (collectively or generically referred to as a processor 121). The processor 121 is coupled via a system bus to a memory 122 and various other components. The memory 122 can include a read only memory (ROM) and a random access memory (RAM). The ROM is coupled to the system bus and may include a basic input/output system (BIOS), which controls certain basic functions of the computing device 120. The RAM is read-write memory coupled to the system bus for use by the processor 121. The memory 122 stores data 124 and software 125.

The data 124 includes a set of values of qualitative or quantitative variables organized in various data structures to support and be used by operations of the software 125. In accordance with one or more embodiments, the memory 122 can accumulate from the sensor devices 110 and/or store the data 124 for use by the computing device 120. In this regard, for example, the data 124 can include the condition monitoring data (e.g., vibrations and temperatures of the bearings; bearing vibration harmonics), along with speed ranges (e.g., a range from a highest expected speed to a lowest expected speed along which a shaft of the axel box 103 can spin/rotate due to the bearings), speed values, root sum squared (RSS) values, bearing designations, unique sensor identifiers, pre-defined intervals for data accumulation, and one or more patterns specific to bearing defects. In one or more examples, the speed of a shaft can be defined as revolutions per minutes, as determined by GPS calculations that utilize approximated rail wheel diameters.

Note further that each of the one or more patterns can be a set of frequencies over time with respect to a specific bearing defect (e.g., as it develops). In this regard, the set of frequencies correlate to defect components/symptoms that are outside normal bearing operations. The patterns coefficients can be weighted, such that when there is a match (e.g., between a pattern frequencies and a defect component/symptom frequencies) it gives a highest correlation value to the best matching pattern with respect to the others. To avoid bias the root-sum squared of the coefficients in each pattern has a value of 1. Examples of the one or more patterns can include a ball pass frequency outer (BPFO) pattern that detects an outer race defect frequency, a ball pass frequency inner (BPFI) radial and axial loadings pattern that detects an inner race defect frequency, a ball spin frequency (BSF) pattern that detects a ball bearing defect frequency, and a cage fundamental train frequency (FTF) pattern that detects a cage defect frequency. Weighting of the patterns can be applied such that the BPFO pattern has 5 harmonics, the BPFI 3 harmonics with 1×N sidebands, the BSF pattern has 1× or 2×BSF and few harmonics with FTF sidebands, and the cage FTF pattern has 1×FTF and a few harmonics without one having a greater bias than the other.

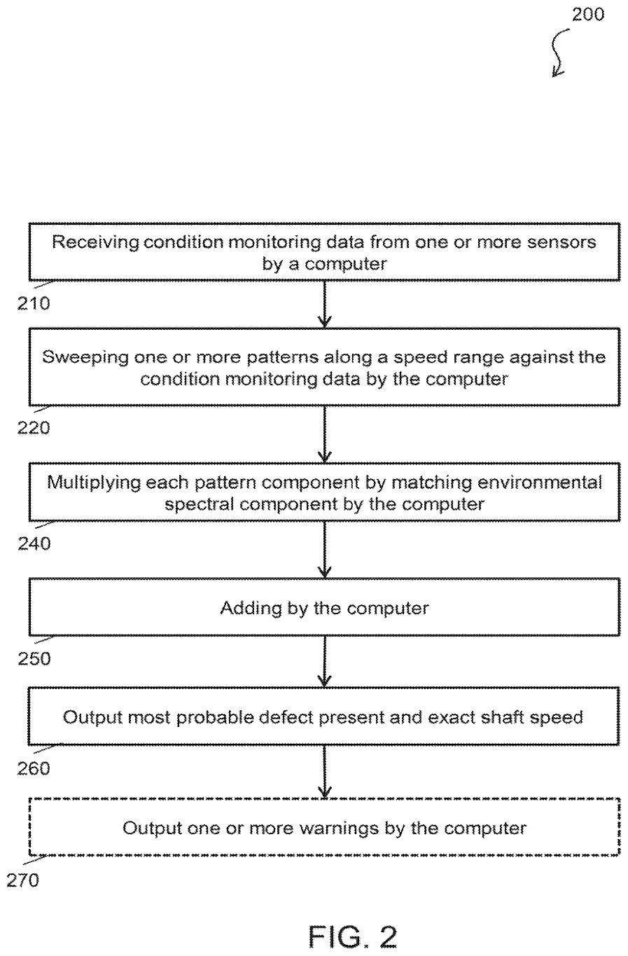

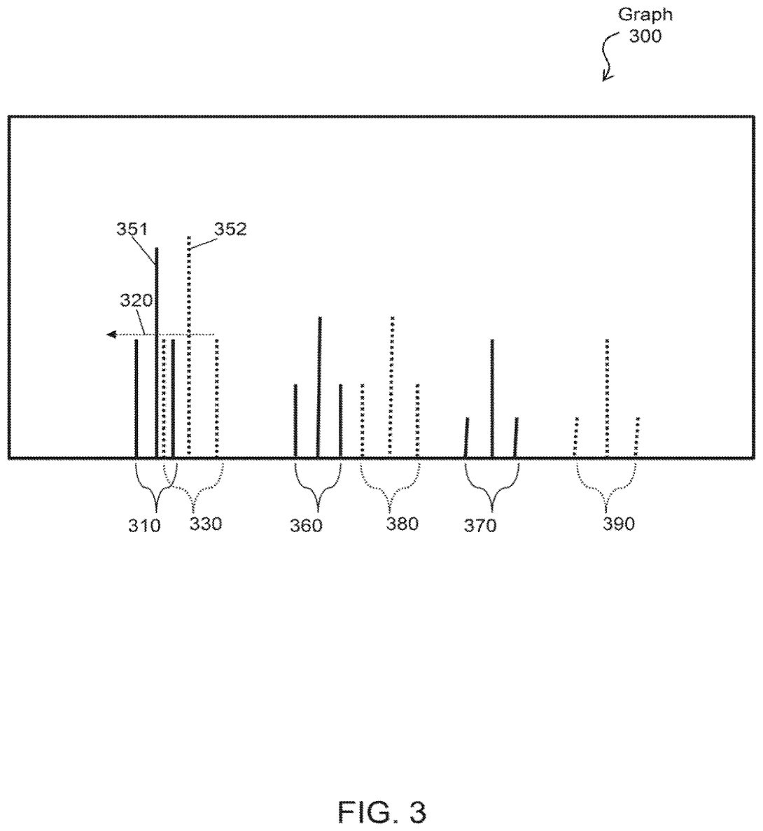

The software 125 is stored as instructions for execution on the processor 121. That is, the memory 122 is also an example of a tangible storage medium readable by the processor 121, where software is stored as instructions for execution by the processor 121 to cause the system 100 to operate, such as is described herein with reference to FIGS. 2-3. Note that the software 125 can reside anywhere within many types of condition monitoring systems and can provide storage, trending, and alarming operations, when a defect is present the SPPC provides the shaft speed, defect type, and frequency for the corresponding systems condition indicator (CI) calculation. For example, in accordance with one or more embodiments, the software can include an SPPC auto-detection algorithm, as described herein. In general, the SPPC auto-detection algorithm can be implemented by the computing device 120 to auto-detect bearing defects on the bearings of the axle box 103 (e.g., railway axle-box bearings) without the need to know accurate shaft speed, thus saving costs (e.g., man-hours) and reducing errors in managing constantly changing wheel diameters.

Further, when the SPPC auto-detection algorithm of the software is executed, the computing device 120 sweeps several specific weighted patterns through a specified speed range while calculating, for each speed step and each pattern type, RSS values of any correlations. In turn, a speed is identified as the speed that provided a largest value, and a defect type is identified by the specific pattern that gave that largest value. If no defect components/symptoms are present, then software does not take note of the speed (e.g., as it is not important). If defect components/symptoms are present, these identified defect components/symptoms are associated with the specific pattern to calculate the shaft speed, frequency of a bearing defect, and type of a bearing defect.

The computing device 120 includes one or more input/output (I/O) adapters 128 coupled to the system bus. The one or more I/O adapters 128 may include a small computer system interface (SCSI) adapter that communicates with the system memory 122 and/or any other similar component. The one or more I/O adapters 128 may include an NFC transponder that communicates with the NFC transponders of the sensor devices 110. For example, the one or more I/O adapters 128 can interconnect the system bus with a network 130, which may be an outside network, enabling the system 100 to communicate with other such systems (i.e., a server 140).

The system 100 also includes the network 130 and the server 140. The network 130 includes a set of computers connected together, sharing resources. The network 1280 can be any type of network, including a local area network (LAN), a wide area network (WAN), or the Internet, as described herein. The server 140 comprises a processor 142 and a memory 144 (as described herein) and provides various functionalities to the computing device 120, such as sharing and storing the data 124, providing processing resources, and/or performing computations (e.g., implementing the software 125).

In accordance with one or more embodiments, for example, the server 140 can be a cloud hosted condition monitoring system that executes by the processor 142 the software (e.g., the software 125 including the SPPC auto-detection algorithm) stored in the memory 144. Further, at various pre-defined intervals (e.g., such as while the railcar 101 is parking in a rail yard at the end of use), the cloud hosted condition monitoring system of the server 140 downloads and stores the data (e.g., the data 124, including the unique sensor identifiers and/or the respective condition monitoring data) from the sensor devices 110. Thus, the software of the server 140 can use the data therein to perform similar operations to the software 125 of the computing device 120.

Turning now to FIG. 2, a process flow 200 implemented by the system 100 is depicted in accordance with one or more embodiments. The process flow 200 can be implemented by any component of the system 100. In general, with respect to the process flow 200, the speed is unknown while bearing details are known. That is, while an exact shaft speed (e.g., rpm) is unknown, the exact bearing details (e.g., the bearing defect frequencies) are known and operating within a certain band (e.g., a narrow band width of +/−10% and/or a wide band width of +/−40%). Note the band can be centre fixed or derived by GPS process. The process flow 200 can be further enhanced by “zeroing” the spectral carpet noise and peaks not identifiably higher than the carpet by various methods.

In convention condition monitoring, if the speed variance of a bearing is small, a fixed central speed is configured with a large search band (e.g., +/−5% or more); however, this can lead to false detections/alarms (e.g., false positives) as there is a larger probability of selecting spectral components from other sources than the defect. This then requires a lot of man-hours for the analyst to manually analyse the spectra and other machine information as to accept or discard the alarm. In contrast, the process flow 200 provides the technical effect and benefit of reducing false positives by using the certain band described herein.

The process flow 200 begins at block 210, a computer (e.g., the computing device 120 and/or the server 140) receives/accumulates condition monitoring data from one or more sensors (e.g., the sensors devices 110). In accordance with one or more embodiments, the condition monitoring data, along with other data described herein, can be transmitted (e.g., as represented by double arrows 119 in FIG. 1) from the sensor devices 110 to the computing device 120. More particularly, the condition monitoring data includes vibration harmonics of bearings. The computing device 120 can further forward through the network 130 the condition monitoring data, along with other data described herein, to the server 140. Thus, both the computing device 120 and the server 140 accumulate sufficient information to support execution of the process flow 200. The accumulation of the condition monitoring data can occur at pre-defined intervals and, in some cases, the accumulation is performed twice a day (e.g., before the railcar 101 leaves a rail yard and after it returns).

At block 220, the computer (e.g., the computing device 120 and/or the server 140) sweeps one or more patterns along a speed range against the condition monitoring data. In accordance with one or more embodiments, the computing device 120 and/or the server 140 can have stored in their respective memories 122 and 144 a speed range. This speed range can be predefined from a highest expected speed to a lowest expected speed for the condition at the time of the measurement and include a plurality of speed steps. According to a non-limiting embodiment, the defect pattern is “swept” across a frequency range derived from a speed range in many iterations, where each iteration is referred to as a “speed step. Further, the computing device 120 and/or the server 140 can execute the software (e.g., the software 125) to sweep/apply these patterns at each speed step of the speed range, which calculates RSS values of speed/pattern correlations for each speed step and each pattern type (e.g., by a fraction of a bin at a time of the highest frequency component). One or more bins correspond to a spectrum, such that if you have 1000 hertz spectrum with 800 lines, each bin for each line has a value of how much vibration energy is associated with a center frequency of that bin (e.g., width of 1.25 hertz).

Turning to FIG. 3, a graph 300 is depicted according to one or more embodiments. The graph 300 illustrates an example of vibration harmonics 310 that are being swept 320 by a pattern 330 of an SPPC auto-detection algorithm. A vibration component frequency 351 is identified by a pattern component 352. In one or more embodiments, each pattern component 352 corresponds to several components defined by the number of orders and the number of sidebands, either side of each order. During the sweep, the pattern components 352 become coincidental to the vibration components 351. As the pattern components 352 become coincidental to the vibration components 351, the product obtained by multiplying the RSS (root sum squared) value of the pattern component weighting values by the corresponding spectral bin values they are aligned to in that sweep step reaches a maxima for that pattern. Accordingly, out of the several types of defect patterns, the one with the largest maxima value identifies the defect type most likely to be present. As shown, the graph 300 also illustrates other examples of vibration harmonics 360 and 370 being respectively swept by pattern components 380 and 380 of an SPPC auto-detection algorithm. In one or more non-limiting embodiments, each implemented bearing has a known or predetermined bearing defect frequency. Accordingly, an accurate speed can be identified by based, at least in part, on the known bearing defect frequencies ratios (i.e. bearing type), thereby allowing a narrow search band to identify defect frequency components (i.e., a frequency at which a defect of component occurs). In this manner, the number of false positives can be significantly reduced thereby increasing the confidence when a true positive is flagged by the software (e.g., the software 125). This increases the reliability of detection (e.g., alarm) by the software and reduces the number of man-hours required. Note also that pattern weighting is such that if more than one pattern crosses a set of spectral components only one having the best match (probability) gives the highest value.

At block 240, multiplying each pattern component (e.g., of the one or more patterns) by a matching environmental spectral component by the computer. In some example embodiments, multiplying each pattern component of the one or more patterns by a matching environmental spectral component is performed using interpolated matching environmental spectral components. In other example embodiments, multiplying each pattern component of the one or more patterns by a matching environmental spectral component is performed using quadratic peak interpolated matching environmental spectral peaks. At block 250, adding by the computer. The adding by the computer includes adding the pattern components together. In some example embodiments, the pattern components can be added together using a root sum squared (RSS). The adding identifies one or more results at operation 260. The results include, but are not limited to, a most probable defect, bearing defect frequency ratios, and an accurate shaft speed, i.e., the exact or actual shaft speed determined by the presence of the defect in the vibration signal and the known bearing defect ratios.

At dashed-block 270 (e.g., optional block), the computer outputs the one or more results. In this regard, a technician can readily ascertain concerns with any bearings being monitored by the computer and take remedial action (e.g., replace or repair the bearings). Note that if no defect components are present, it is not of importance that the speed is known. If other spectral components are present within the condition monitoring data (e.g., from the machine dynamics/mechanics), the other spectral components can also have a pattern associated therewith to calculate a speed in the absence of a bearing defect.

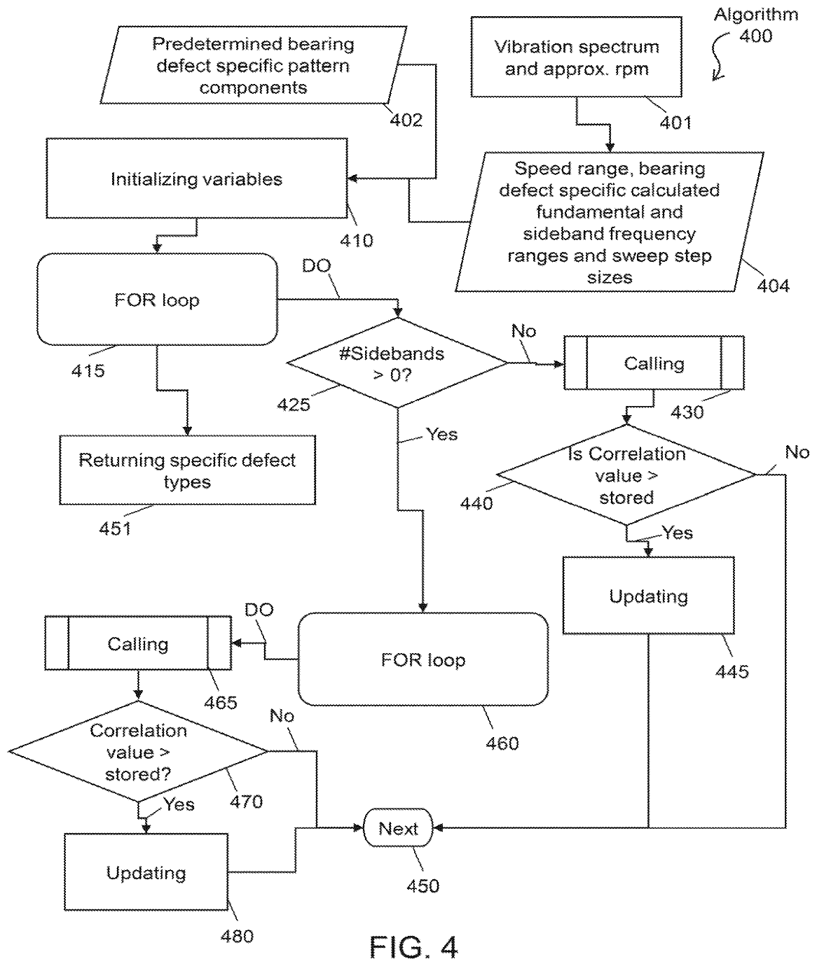

FIG. 4 depicts an example algorithm 400 in accordance with one or more embodiments. The example algorithm 400 begins at blocks 401, 402 and 404, where initial conditioning monitoring data is received. The initial conditional monitoring data includes, but is not limited to, a vibration spectrum of enveloped acceleration measurement with respect to shaft rpm (as shown in block 401), predetermined bearing defect specific pattern components (as shown in block 402), calculated speed range, bearing defect specific calculated fundamental and sideband frequency ranges, and sweep step sizes (as shown in block 404). In one or more non-limiting embodiments, when the GPS has an error range (e.g., +/−5%) and the wheel diameter has an error value (e.g., +/−5% from the stated diameter used to calculate RPM (shaft speed)), then the speed range to sweep the patterns through includes an acceptable minimum error value based, at least in part, on the GPS error range and wheel diameter error value, which in this example would be at least about +/−10%.

Then, at block 410, the example algorithm 400 initializes variables. For example, a correlation value, fundamental frequency, and a sideband frequency are each initialized to zero. At block 415, a FOR loop is entered for each vibration harmonic of a bearing. More particularly, for a fundamental range (low to high), the example algorithm 400 steps through fundamental step sizes to sweep patterns across the vibration harmonics. The FOR loop includes, at decision block 425 (as shown by the DO arrow), determining whether a number of sidebands is greater than zero. If the number of sidebands is not greater than zero, the example algorithm 400 proceeds to block 430 (e.g., following the “No” arrow).

At block 430, a correlate function is called, and at decision block 440, it is determined whether any of the correlation values are greater than stored values. If the correlation values are greater than stored values, the example algorithm 400 proceeds to block 445 (e.g., following the “Yes” arrow). Then, the example algorithm 400 goes to the next pattern at block 450 by returning to the block 415. Upon returning to block 415, the example algorithm 400 returns specific defect types (e.g., for any identified correlation value, fundamental frequency, and side band frequency; as shown at block 451).

At block 445, the correlation value and frequencies are updated. If the correlation values of the sidebands are not greater than stored values, the example algorithm 400 proceeds to block 450 (e.g., following the “No” arrow).

Returning to decision block 425, if the number of sidebands are greater than zero, the example algorithm 400 proceeds to block 460 (e.g., following the “Yes” arrow). At block 460, another FOR loop is entered for each vibration harmonic of a bearing. More particularly, for a sideband range (low to high), the example algorithm 400 steps through sideband step sizes to sweep patterns across the vibration harmonics. At block 465, a correlate function is called. At decision block 470, it is determined whether any of the correlation values are greater than stored values. If the correlation values are greater than stored values, the example algorithm 400 proceeds to block 450 (e.g., following the “No” arrow). If the correlation values are greater than stored values, the example algorithm 400 proceeds to block 480 (e.g., following the “Yes” arrow). At block 480, the correlation value and frequencies are updated. Then, the example algorithm 400 proceeds to block 450.

One embodiment of the present invention is directed to software configured for monitoring a bearing for defects and operates as follows. The software preferably reduces the incidence of false positive error indications and also increases the reliability and accuracy of the specific error actual affecting the bearing. The invention includes a method of monitoring a bearing on a machine. In some instances, it is not necessary to know the speed of operation of the bearing to accomplish enhanced error detection.

The method preferably, but not necessarily, includes the step of providing a shaft disposed on a machine. The shaft has a first axial end. Those of ordinary skill in the art will appreciate from this disclosure that the bearing can be located on wheel, axle box, or any other suitable location where vibrations from bearings can be detected without departing from the scope of the present invention. For example, the sensors can be located next to machinery.

The method preferably, but not necessarily, includes the step of providing a first bearing which may be disposed on the first axial end of the shaft. Additionally, the method may include providing a first sensor 110, located on the first bearing and configured to provide first bearing condition monitoring data which comprises vibration data.

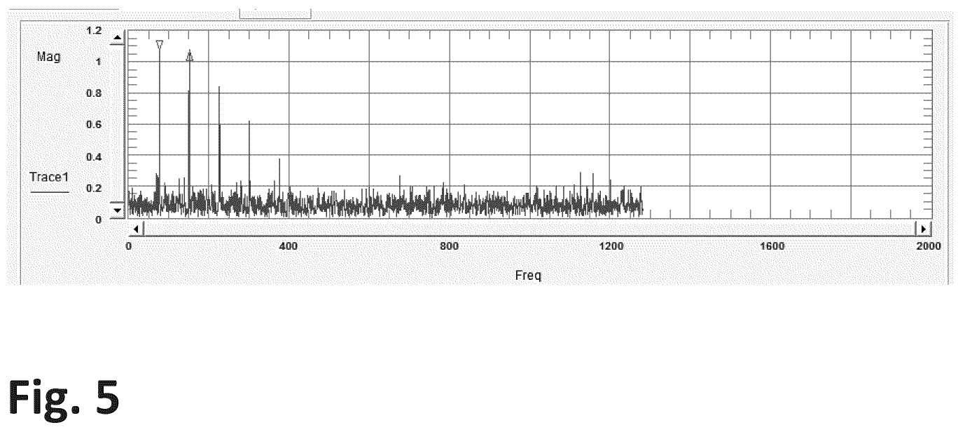

Referring to FIG. 5, a frequency spectrum illustrating the fundamental frequency of a BPFO defect is shown. There is a lack of a relatively few side bands with near shaft speed delta frequencies around each harmonic of the defect fundamental frequency. This spectrum could be the first bearing condition monitoring data when a BPFO defect is present.

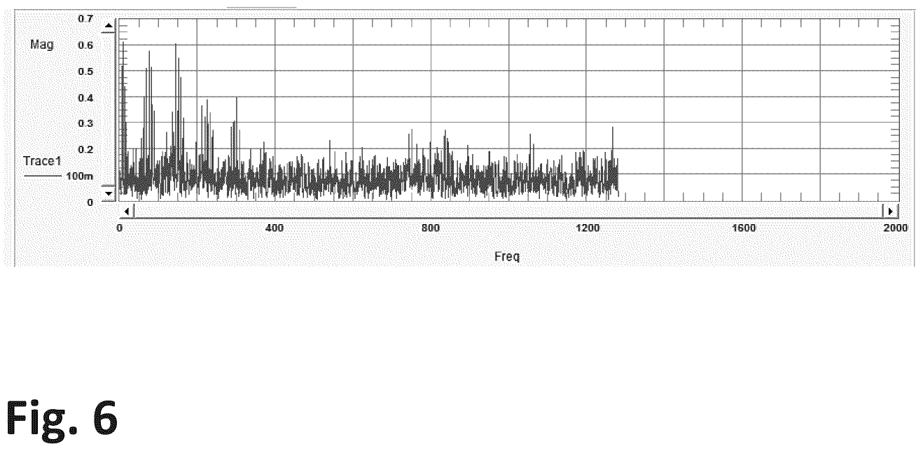

Referring to FIG. 6 a frequency spectrum illustrating the fundamental frequency of a BPFI defect is shown. There are significant amount of side bands with side bands near shaft speed delta frequencies around each harmonic of the defect fundamental frequency. This spectrum could be the first bearing condition monitoring data when a BPFI defect is present. Those of ordinary skill in the art will appreciate from this disclosure that the exact type of errors shown if FIGS. 5 and 6 is not relevant, but that each type of bearing defect can provide different spectrum as the first bearing condition monitoring data without departing from the scope of the present invention.

The method preferably, but not necessarily, includes the step of providing a computer and/or server 140 in communication with the first sensor 110. The computer preferably automatically receives the first bearing condition monitoring data and process the vibration data into frequency domain to generate a spectral array of amplitudes and frequencies.

The method preferably, but not necessarily, includes the step of providing a plurality of patterns each representing a particular defect symptom. The patterns preferably, but not necessarily, are each comprised of an array of relative frequencies that can be weighted such that their root-sum-squared is a maximum of 1 regardless of the size of the array of relative frequencies so that a maximum match between the first bearing condition monitoring data and the one of the plurality of patterns which corresponds to the defect yields a pattern correlation value of greatest magnitude.

The step of providing the plurality of patterns further may comprise the design of the plurality of patterns being determined by prior bearing data for bearings having known operating conditions, and used in the same machine. Alternatively, the design of the plurality of patterns may be determined by prior bearing data for bearings having known operating conditions, and used in a comparable class of machines. Alternatively, the design of the plurality of patterns may be determined by prior bearing data from multiple bearings having a known operating condition, and used in multiple machines. Alternatively, the design of the plurality of patterns may be determined by prior bearing data for bearings having known operating conditions. Those of ordinary skill in the art will appreciate from this disclosure that any suitable source of data for the shape and design of the plurality of patterns can be used without departing from the scope of the present invention.

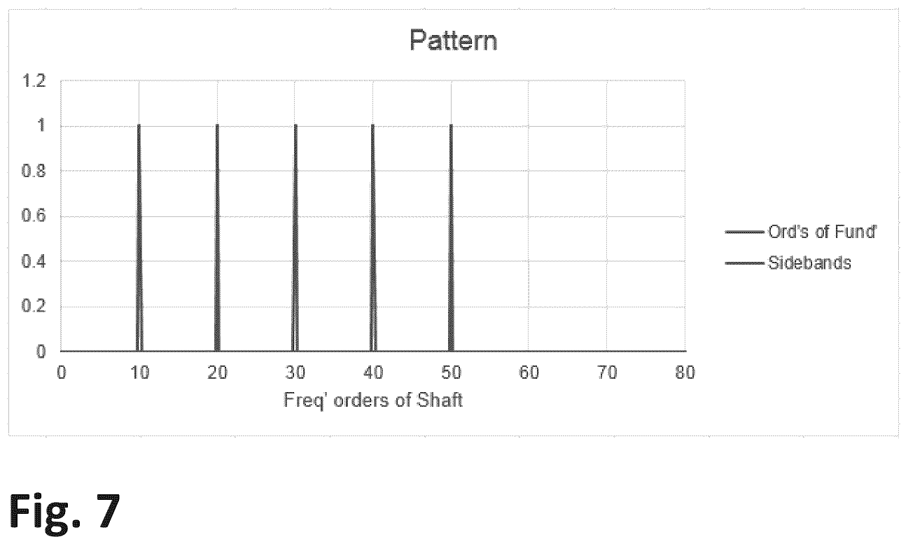

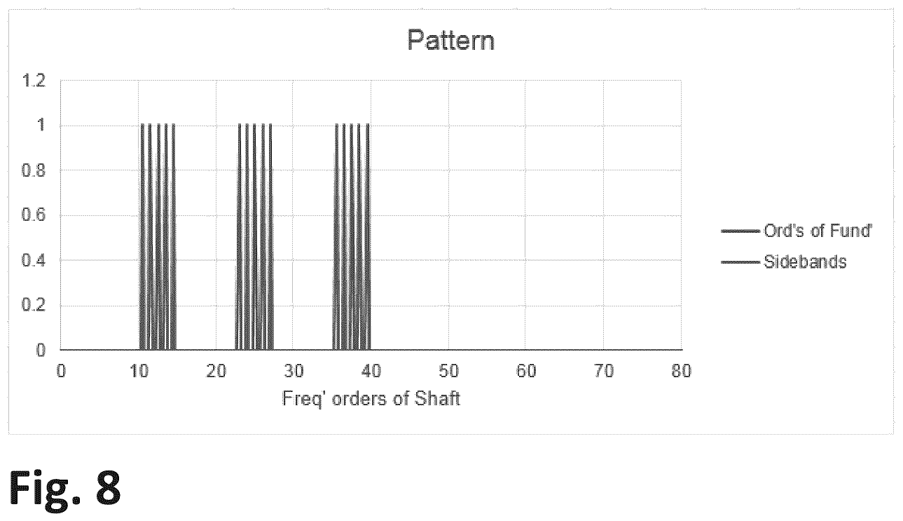

FIG. 7 illustrates an exemplary pattern of a TBU BPFO pattern without weighting or normalization. FIG. 8 illustrates an exemplary pattern of a TBU BPFI pattern without weighting or normalization.

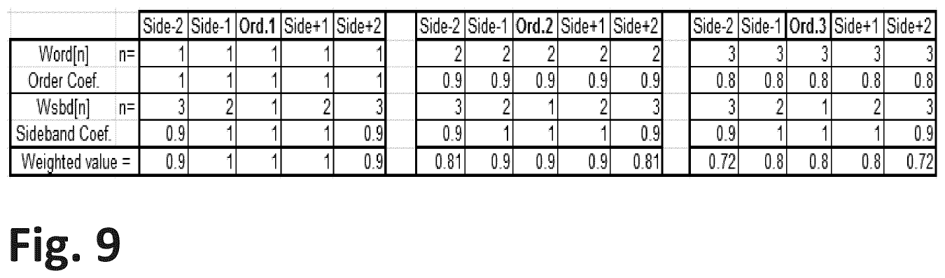

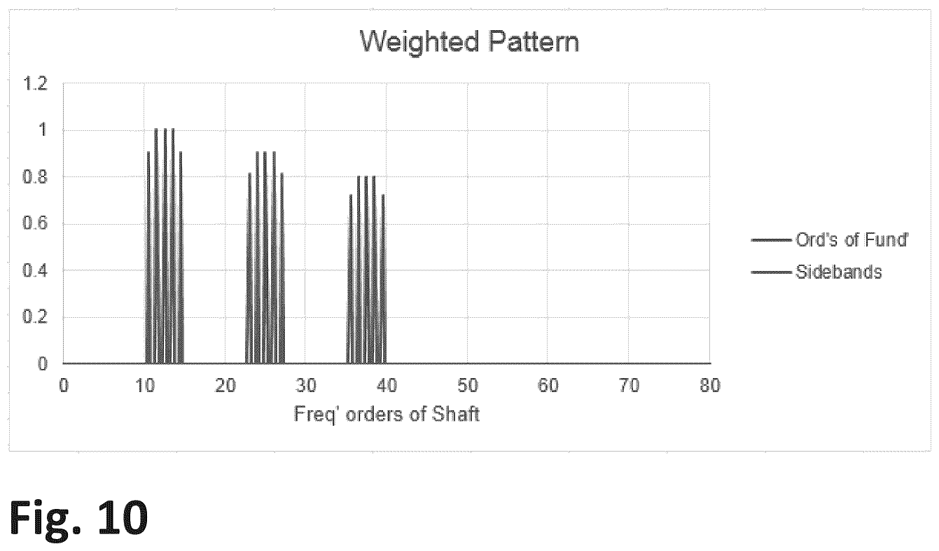

The patterns can be weighted to make comparisons with the first bearing condition monitoring data more accurate. FIG. 9 is an exemplary table illustrating a weighting calculation method from orders and sideband weighting coefficients. FIG. 10 illustrates the weighted pattern of a TBU BPFI pattern after weighting, but without normalization.

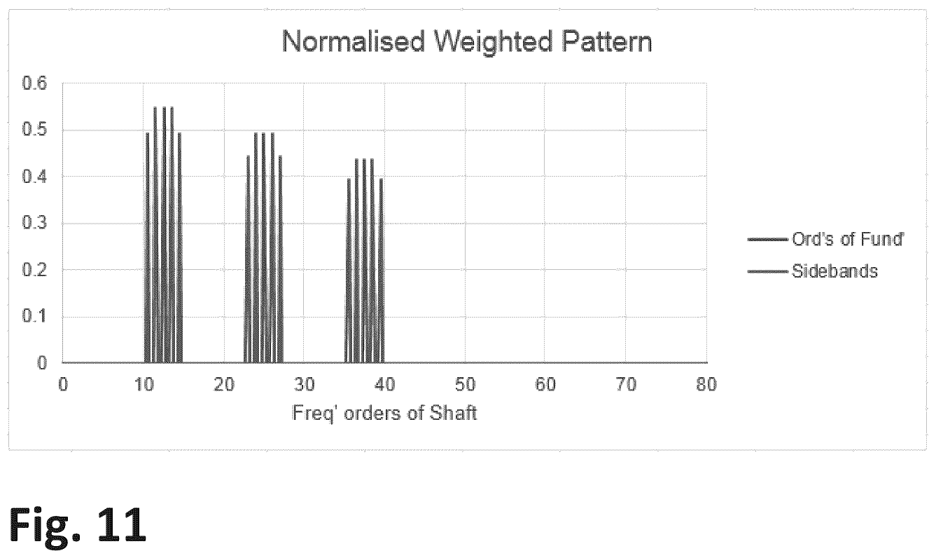

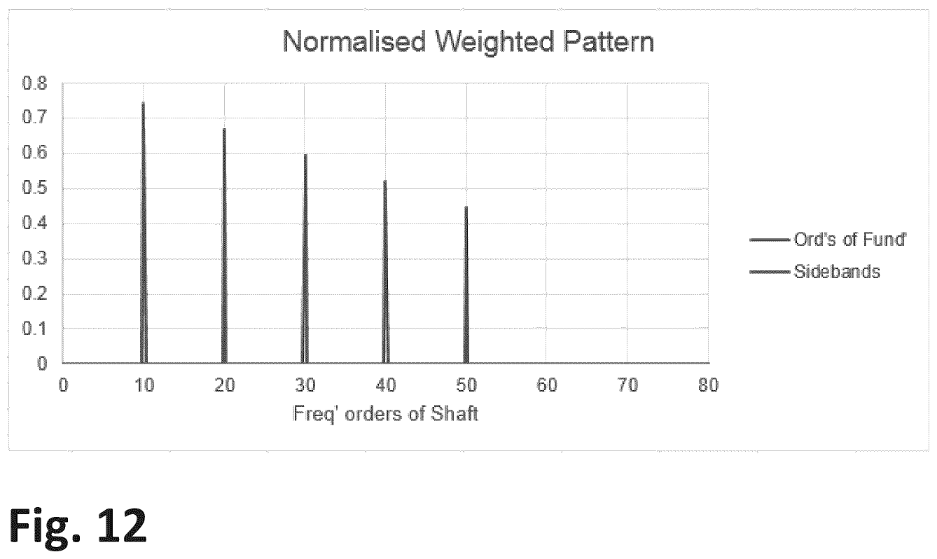

Each pattern is preferably, but not necessarily, normalised by dividing each weighted pattern component by the Square Root of the Root-Sum-Squared of the whole weighted pattern. This may not necessarily be a true normalisation (i.e. to unity), but may provide a better “probability” representation at the outcome of the pattern sweep. Those of ordinary skill in the art will appreciate from this disclosure that any suitable normalization technique may be used without departing from the scope of the present invention. FIG. 11 illustrates the normalized weighted pattern of a TBU BPFI pattern after weighting and normalization. FIG. 12 illustrates the normalized weighted pattern of a TBU BPFO pattern after weighting and normalization. In this example the pattern weighted components have been relatively scaled so their RSS=1. It is preferable that the same procedure is followed for the spectrum pattern for the BPFI symptom.

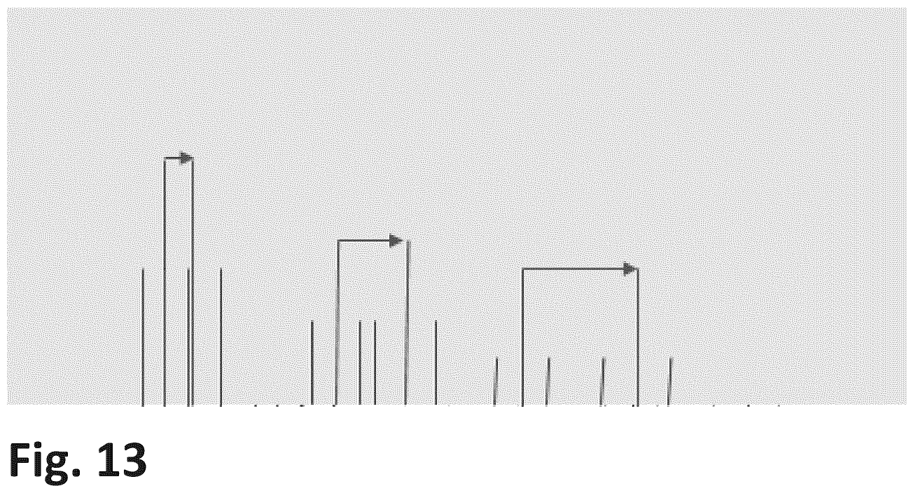

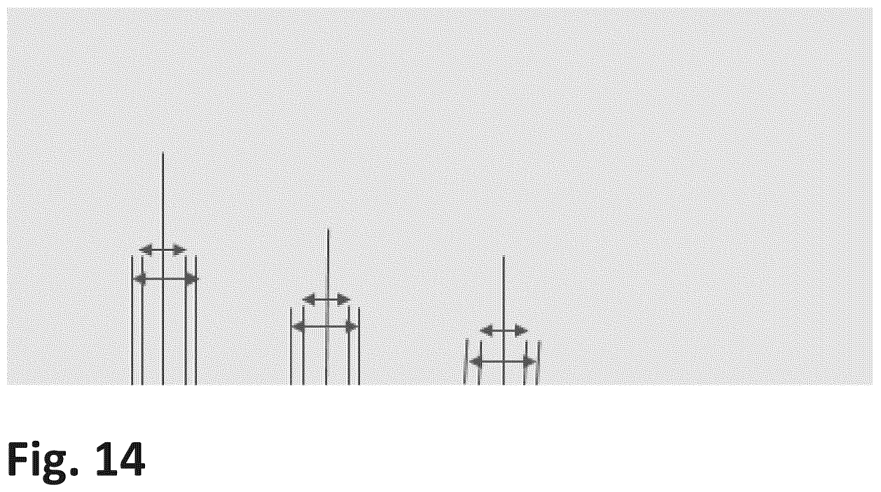

FIG. 13 illustrates the sweep pattern of the fundamental frequency range of the fundamental and its harmonics. Only the pattern is shown and not the frequency/spectrum. FIG. 14 illustrates how for each weep step of the fundamental frequency a sideband sweep can be performed around the fundamental frequency and its harmonics. For each of these steps the pattern normalized weighted component values are preferably multiplied against the matching frequency spectrum components' amplitude values and the RSS of their values determined as the “correlation values” for each step.

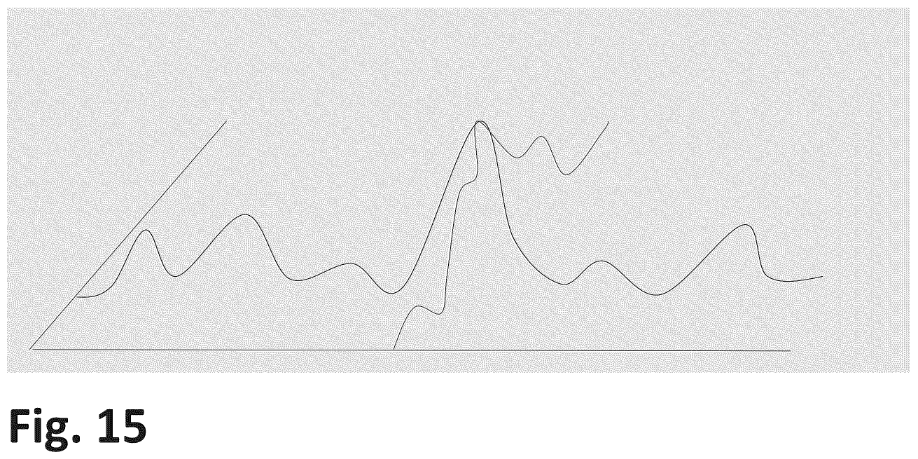

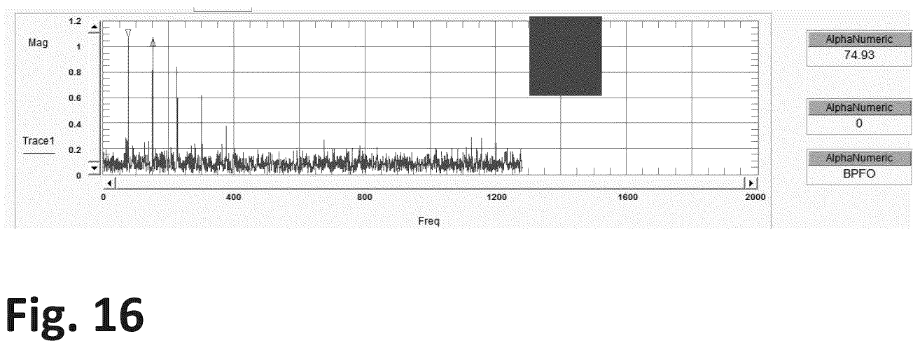

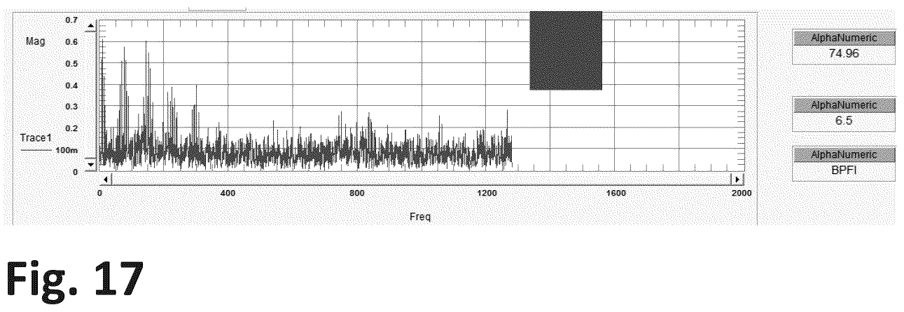

FIG. 15 illustrates an exemplary vertical axis that corresponds to correlation values and a diagonal axis that corresponds to sideband frequency steps. That is: Vert axis ¦=correlation values; diagonal axis/=sideband frequencies steps; and horizontal axis−=fundamental frequencies steps. The correlation values of a BPFI pattern sweeping across the fundamental frequencies in range provided and for each of them sweeping across sideband values in range provided to show figures illustrating how the sweep correlation values where the “maxima correlation value” was found may also providing the most probable fundamental and sideband frequencies. FIG. 16 illustrates a condition where due to BPFO “maxima correlation value” being higher than the BPFI the defect is classified as BPFO. FIG. 17 illustrates a condition where due to BPFI “maxima correlation value” being higher than the BPFO the defect is classified as BPFI.

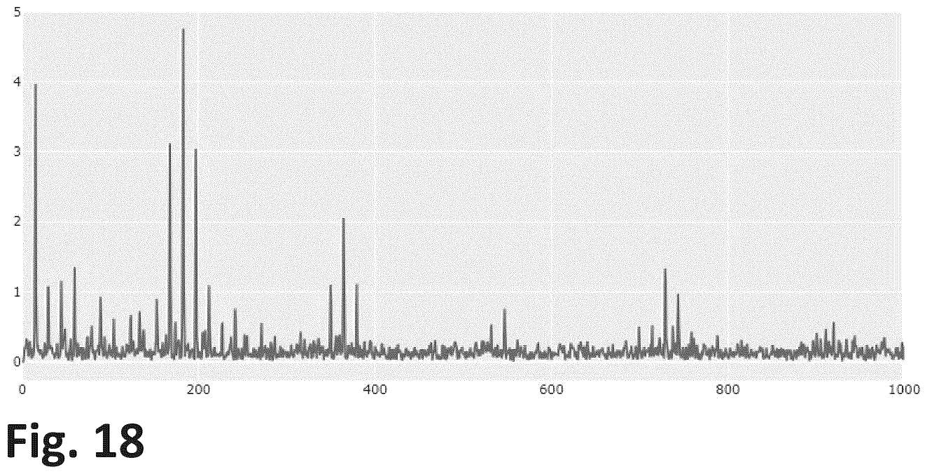

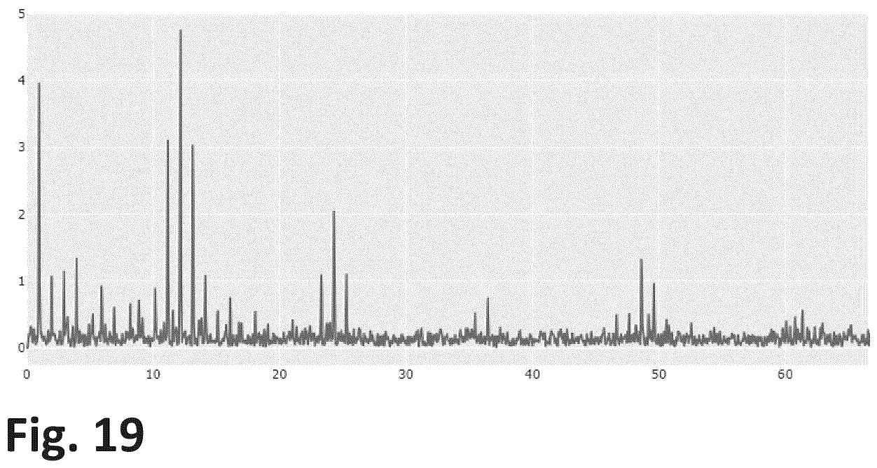

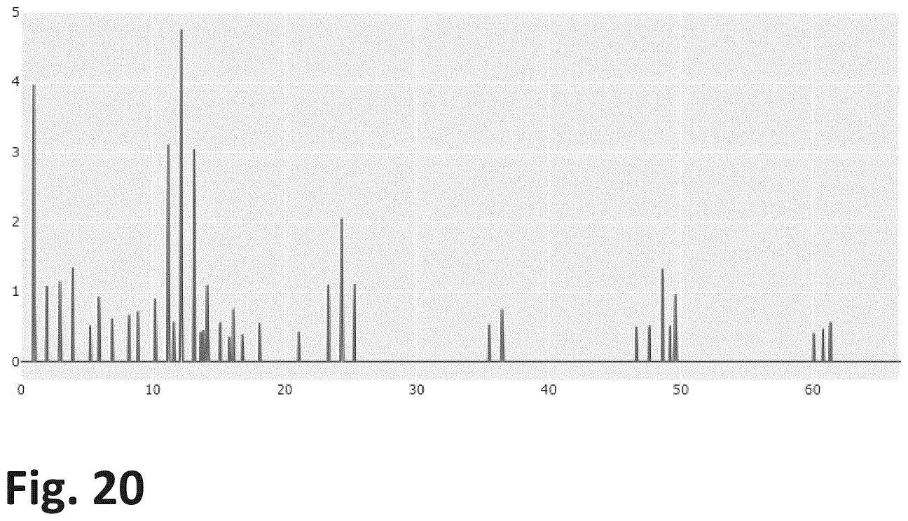

FIG. 18 illustrates the acquired spectrum with the x-axis showing frequency in Hertz. FIG. 19 illustrates the condition where the approximate shaft speed is known or calculated with the x-axis showing orders of running speed. FIG. 20 illustrates a condition when a noise filter is applied to the spectrum which converts all spectral components with values below +10 db above the local carpet level to identify the peaks of interest to be included in the peak arrays which are far fewer in number than the peaks and spectral bins in the raw spectra. A noise filter may be applied to the spectrum which converts all spectral components with values below approximately +10 db above the local carpet level to identify the peaks of interest to be included in the peak arrays which are far fewer in number than the peaks and spectral bins in the raw spectra.

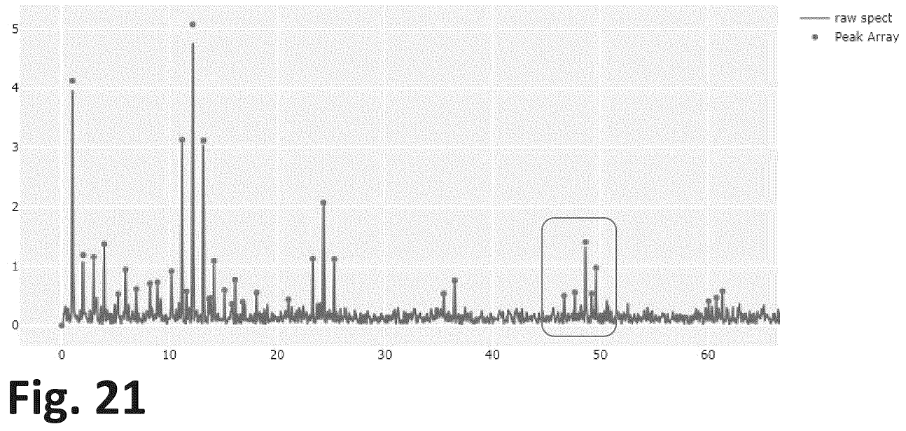

FIG. 21 illustrates when the raw spectrum and applying of the quadratic peak interpolation in the noise filtered spectrum, to extract the exact frequency and amplitude of each peak thus creating a peak array list represented by the dots. This may be accomplished by going back to the raw spectrum and applying the quadratic peak interpolation to each peak identified in the noise filtered spectrum, thus extracting the exact frequency and amplitude of each peak (as its energy can be spread across 3 spectral bins) thus creating the “peak array” list (dots).

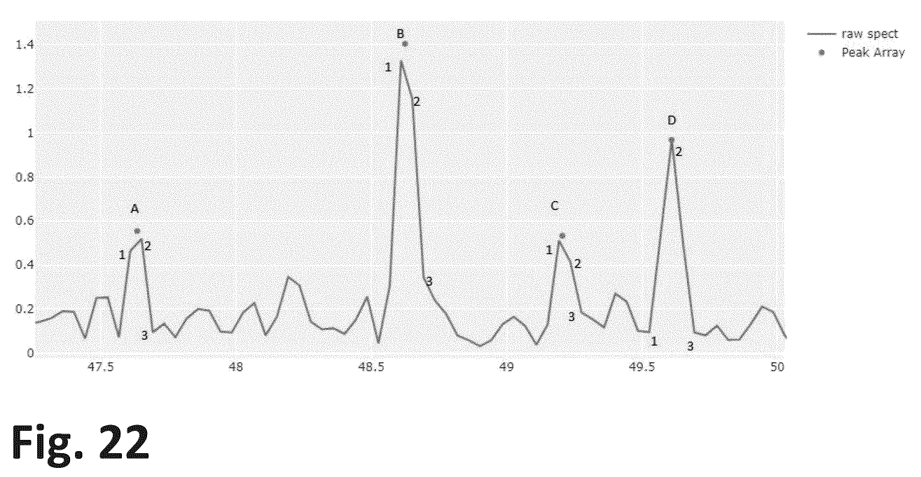

FIG. 22 illustrates the quadratic peak interpolation method being used to calculate the peaks center frequency and true amplitude using the three highest values adjacent to the spectral peak maxima point. The quadratic peak interpolation method or any other suitable method may be used to calculate the peaks centre frequency and true amplitude using the three highest values adjacent to the spectral peak maxima point.

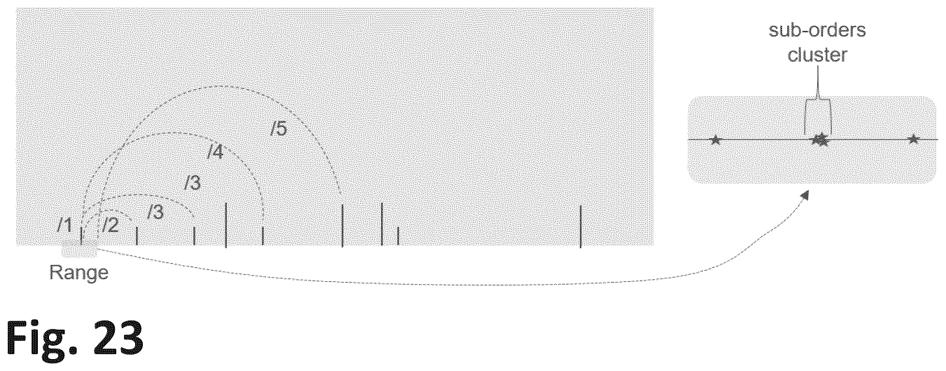

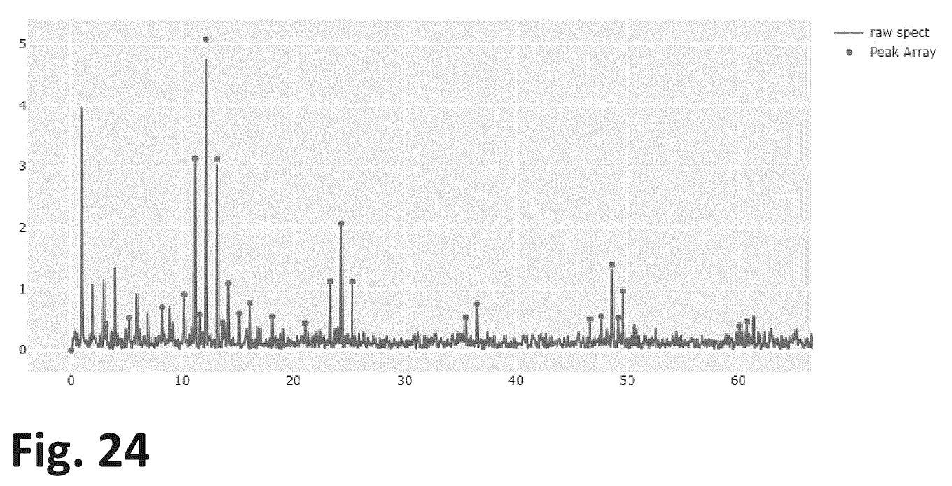

FIG. 23 illustrates the operation of the “reverse sweep” method of identifying possible harmonic (orders of) fundamental frequencies for each component in the “peak array” list with clustering into groups or outliers. This can be used to identify running speed and harmonics within its range and remove them from the “peak array” list prior to searching by the same method the bearing defect ranges. FIG. 24 illustrates a condition when running speed harmonics are removed with the “peak arrays” shown as dots.

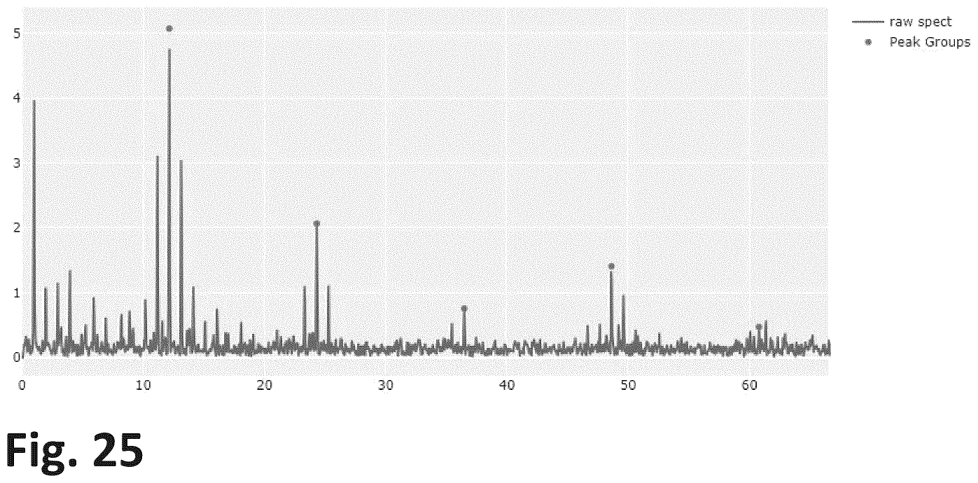

FIG. 25 illustrates the results of performing the sideband reverse sweep with clustering in the bearing BPFI sideband defect range and sideband group filtering to identify feasible sidebands relating to the BPFI defect. The previously designed patterns are applied to these results when BPFO and BPFI ranges overlap to improve classification of the defect type by their “correlation values.”

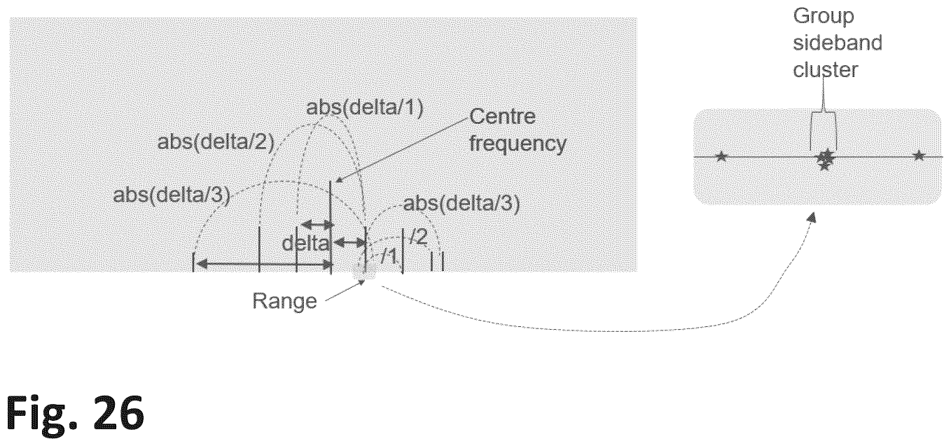

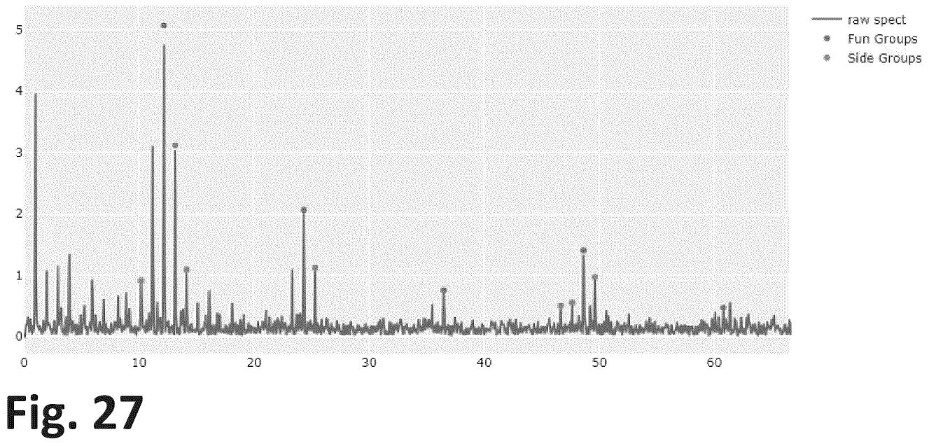

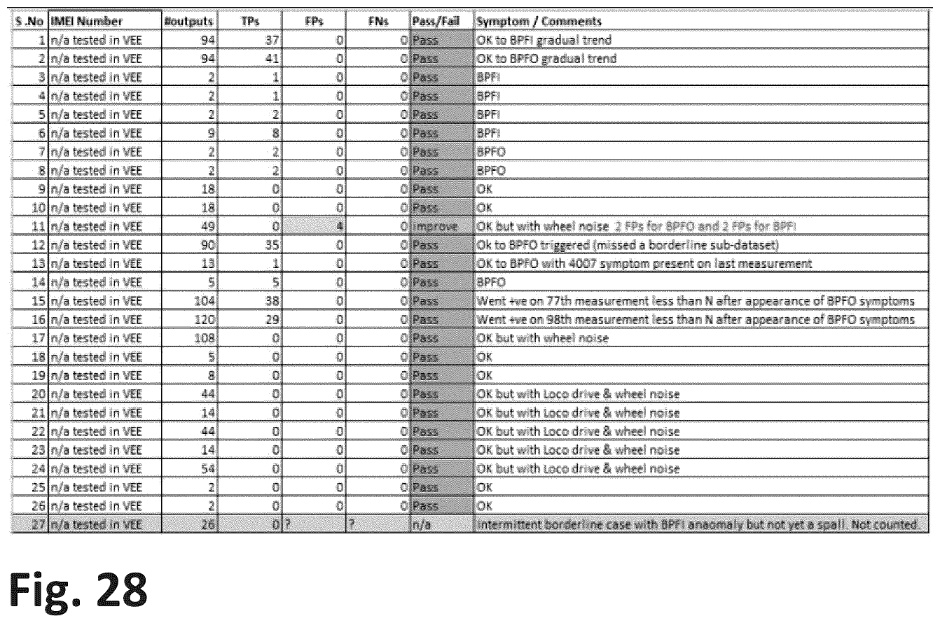

FIG. 26 illustrates the reverse sweep method of identifying possible sidebands of each harmonic (orders of) fundamental frequencies identified as being related to a clustering into sideband group or outliers. FIG. 27 illustrates exemplary results of a sideband reverse sweep with clustering in the bearing BPFI sideband defect range and sideband group filtering to identify feasible sidebands relating to the BPFI defect. The previously designed patterns are applied to these results when BPFO and BPFI ranges overlap to improve classification of the defect type by their “correlation values”. FIG. 28 is a chart of experimental results from field trials of one embodiment of the present invention.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of monitoring a bearing on a machine without having to know the speed of operation of the bearing, comprising the steps of:
providing a shaft disposed on the machine, the shaft having a first axial end;
providing a first bearing disposed on the first axial end of the shaft;
providing a first sensor, located on the first bearing and configured to provide first bearing condition monitoring data which comprises vibration data;
providing a computer in communication with the first sensor;
automatically receiving, by the computer, of the first bearing condition monitoring data and processing the vibration data into frequency domain to generate a spectral array of amplitudes and frequencies;
providing a plurality of patterns each representing a particular defect symptom and each comprising an array of relative frequencies and being weighted such that their root-sum-squared is a maximum of 1 regardless of the size of the array of relative frequencies so that a maximum match between the first bearing condition monitoring data and the one of the plurality of patterns which corresponds to the defect yields a pattern correlation value of greatest magnitude; and
wherein the computer, upon receiving the first bearing condition data from the first bearing, compares a first pattern thereto to determine a pattern correlation value for the first pattern.

2. The method of claim 1, further comprising the step after comparing the first pattern to the first bearing condition data, the computer compares a second pattern thereto to determine a pattern correlation value for the second pattern, the one of the plurality of patterns having the largest pattern correlation value corresponds to the defect in the bearing.

3. The method of claim 1, wherein the step of providing the plurality of patterns comprises the design of the plurality of patterns being determined by prior bearing data for bearings having known operating conditions using a plurality of patterns having varying: harmonics and sidebands.

4. The method of claim 1, wherein the step of providing the plurality of patterns further comprises the design of the plurality of patterns being determined by prior bearing data for bearings having known operating conditions, and used in the same machine.

5. The method of claim 1, wherein the step of providing the plurality of patterns further comprises the design of the plurality of patterns being determined by prior bearing data for bearings having a known operating conditions, and used in a comparable class of machines.

6. The method of claim 1, wherein the step of providing the plurality of patterns further comprises the design of the plurality of patterns being determined by prior bearing data from multiple bearings having known operating conditions, and used in multiple machines.

7. The method of claim 1, wherein the step of providing the shaft further comprises the machine being a railcar and the first bearing is located in an axle box.

8. The method of claim 1, wherein the step of providing the shaft further comprises the machine being a railcar and the first bearing is located in an axle box.

9. A method of monitoring a bearing on a machine without having to know the speed of operation of the bearing, comprising the steps of:
providing a shaft disposed on the machine, the shaft having a first axial end;
providing a first bearing disposed on the first axial end of the shaft;
providing a first sensor, located on the first bearing and configured to provide first bearing condition monitoring data which comprises vibration data;
providing a computer in communication with the first sensor;
automatically receiving, by the computer, of the first bearing condition monitoring data and processing the vibration data into frequency domain to generate a spectral array of amplitudes and frequencies;
providing a plurality of patterns each representing a particular defect symptom and each comprising of arrays of relative frequencies, relative to the fundamental frequency thereof, and corresponding weighting values such that their root-sum-squared is a maximum of 1, regardless of the number of frequency components therein, so that a maximum match between the first bearing condition monitoring data and the one of the plurality of patterns which corresponds to the defect yields a highest value; and
wherein the computer, upon receiving the first bearing condition data from the first bearing, compares a first pattern thereto to determine a pattern correlation value for the first pattern.

10. The method of claim 9, wherein the step of providing the plurality of patters comprises the design of the plurality of patterns being determined by prior bearing data for bearings having known operating conditions.

11. The method of claim 9, wherein the step of providing the plurality of patterns further comprises the design of the plurality of patterns being determined by prior bearing data for bearings having known operating conditions, and used in the same machine.

12. The method of claim 9, wherein the step of providing the plurality of patterns further comprises the design of the plurality of patterns being determined by prior bearing data for bearings having known operating conditions, and used in a comparable class of machines.

13. The method of claim 9, wherein the step of providing the plurality of patterns further comprises the design of the plurality of patterns being determined by prior bearing data from multiple bearings having a known operating condition, and used in multiple machines.

14. The method of claim 9, wherein the step of providing the shaft further comprises the machine being a railcar and the first bearing is located in an axle box.

15. A method of monitoring a bearing on a machine without having to know the speed of operation of the bearing, comprising the steps of:
providing a shaft disposed on the machine, the shaft having a first axial end;
providing a first bearing disposed on the first axial end of the shaft;
providing a first sensor, located on the first bearing and configured to provide first bearing condition monitoring data which comprises vibration data;
providing a computer in communication with the first sensor;
automatically receiving, by the computer, of the first bearing condition monitoring data and processing the vibration data into frequency domain to generate a spectral array of amplitudes and frequencies;
providing a plurality of patterns each representing a particular defect symptom and each comprising of arrays of relative frequencies, determining a maximum match between the first bearing condition monitoring data and the one of the plurality of patterns which corresponds to the defect which is most probable in view of the first bearing condition monitoring data; and
wherein the computer, upon receiving the first bearing condition data from the first bearing, automatically determines a pattern correlation value for the first pattern.

16. The method of claim 15, wherein the step of providing the plurality of patterns comprises the design of the plurality of patterns being determined by prior bearing data for bearings having known operating conditions.

17. The method of claim 15, wherein the step of providing the plurality of patterns further comprises the design of the plurality of patterns being determined by prior bearing data for bearings having known operating conditions, and used in the same machine.

18. The method of claim 15, wherein the step of providing the plurality of patterns further comprises the design of the plurality of patterns being determined by prior bearing data for bearings having known operating conditions, and used in a comparable class of machines.

19. The method of claim 15, wherein the step of providing the plurality of patterns further comprises the design of the plurality of patterns being determined by prior bearing data from multiple bearings having a known operating condition, and used in multiple machines.

20. The method of claim 15, wherein the step of providing the shaft further comprises the machine being a railcar and the first bearing is located in an axle box.
